(19) United States
(12) Patent Application Publication
(10) Pub. No.: US 2002/0183976 A1
(43) Pub. Date: Dec. 5, 2002

(54) Patient monitoring and recording systems

(76) Inventor: Marvin Jay Pearce, Portland, OR (US)

Correspondence Address: EDWARDS & ANGELL, LLP, Dike, Bronstein, Roberts & Cushman, IP Group, P.O. Box 9169, Boston, MA, 02209, US

(21) Appl. No.: 10/055,791

(22) Filed: Jan. 17, 2002

Related U.S. Application Data
(60) Provisional application No. 60/263,616, filed on Jan. 18, 2001.

(51) Int. Cl. G06F 15/00

(52) U.S. Cl. 702/188

(57) ABSTRACT

Systems and methods are provided for point-of-care patient monitoring and include real-time acquisition, display and transfer of data from one or more patient monitor units (e.g. ECG, blood pressure, temperature, etc.) both locally and to remote sites.

The present application claims the benefit of U.S. provisional application 60/263,616 filed Jan. 18, 2001, which application is incorporated herein by reference in its entirety.

### BACKGROUND OF THE INVENTION

1. Field of the Invention

The invention provides systems and methods for monitoring patients, particularly portable patient and monitoring and recording systems that can be employed in a variety of locations, including acute and sub-acute treatment environments. More particularly, systems and methods of the invention significantly facilitate point-of-care patient monitoring by providing, inter alia, local and remote real-time acquisition, display and transfer of data from one or more patient monitor units (e.g. ECG, blood pressure, temperature, blood oxygen saturation, etc.).

2. Background

A variety of automated health monitors and analysis systems have been reported.

See, for instance, U.S. Pat. Nos. 5,437,278; 5,666,953; 5,778,882; 5,947,907; 6,095,985; and 6,127,129. See also U.S. Pat. No. 4,916,441; 5,417,222; 5,482,050; 5,568,814; 5,664,270; 5,587,717; and 6,057,758.

Devices exist for monitoring a variety of patient parameters such as heart rate, blood pressure, temperature and the like. Certain automated devices also have been utilized, particularly in acute treatment environments such as hospital intensive care units. Monitoring devices also have been utilized in sub-acute treatment areas, e.g. hospital treatment settings that have a relatively higher patient-to-caregiver ratio than an intensive care unit.

Recording and maintaining medical records present an ever-increasing burden to the health care industry. Among other things, data is often manually recorded. For example, in a hospital environment, a nurse or other medical professional will read an output of a patient monitor (e.g. a heartrate monitor) and manually record that information into an electronic database, e.g. via laptop computer that may be present in the patient's room, or through a remotely located computer after making a written record of the data. Such manual input is both burdensome and susceptible to inadvertent entry of incorrect information.

It thus would be desirable to have improved patient monitoring systems and methods.

### SUMMARY OF THE INVENTION

The invention provides substantially improved patient monitoring and recording systems and methods. Systems and methods of the invention are particularly useful for sub-acute treatment applications.

We have found that current patient monitoring devices can exhibit significant drawbacks. Among other things, as noted above, current devices consistently require burdensome transfer of data, particularly manual input or transfer of data. Current patient monitoring devices also often are not optimally adapted for sub-acute treatment environments. In particular, current patient monitoring systems are often optimized for use in acute care areas, where a relatively low patient-to-caregiver ratio exists, reducing the burden and potential error associated with manual data input and transfer.

We now provide an effective data link between one or more patient monitoring units (such as an ECG, heart rate monitor, blood pressure monitor, body temperature monitor, monitor of SpO₂ with pulse rate, etc.) and an ultimate remote residence or user of the data. Specifically, the invention provides an effective link between one or more patient monitoring units and e.g. electronic patient records, a medical practitioner at a site remote from the patient, and the like. Such a direct (non-manual) data link can completely obviate any manual input or transfer of physiological data.

Systems of the invention can receive an output from a monitoring device and directly input that data into electronic patient records, or otherwise transmit the data, e.g. to a medical professional at a remote site. The systems of the invention thus can enable access in real time to an output of a monitoring unit from a remote site as well as local and remote real-time adjustment or other calibration of a monitoring unit.

Preferred monitoring systems of the invention comprise in combination:

i) one or more patient monitoring units such as e.g. an ECG, heart rate monitor, blood pressure monitor, body temperature monitor, monitor of SpO₂ with pulse rate, monitor of drug administration such as an intravenous unit, etc.;

ii) a module unit to receive and manipulate data output of the one or more monitoring units. The electronic receiver or module suitably is capable of converting as necessary data received from one or more monitoring units to a digital format. The module preferably receives data from a plurality of monitoring units; and

iii) a computer unit, e.g. a personal computer, that can receive data transmitted from the module. The computer can display out of the one or more monitoring units and can transfer the data e.g. to an electronic patient record, or to other remote site such as through the Internet to a medical practitioner.

The invention also includes methods for treating or monitoring a patient with a system as disclosed herein, comprising monitoring a patient with one or more monitoring units, receiving output of the one or more monitoring units via an electronic module, digitizing the received information as necessary, and transmitting the digital information to a computer unit, such as a laptop computer or other personal computer. The received digital information can be reviewed and manipulated at the computer unit and further transmitted to a remote site as desired.

Other aspects of the invention are disclosed infra.

### BRIEF DESCRIPTION OF THE DRAWINGS

FIGS. 1A and 1B show components of a monitoring system of the invention.

FIG. 2 shows an initial screen display of a computer unit of a system of the invention.

FIGS. 3A and 3B show exemplary computer unit screen displays for a system of the invention.

FIGS. 4A and 4B show exemplary screen formatting operations of a computer unit

FIG. 5 shows an exemplary computer unit alarm screen setting of a system of the invention.

FIGS. 6A and 6B show exemplary computer unit control screens for ECG monitors of systems of the invention.

FIGS. 7, 8 and 9 show exemplary computer unit control screens for pulse oximetry (SpO₂), non-invasive blood pressure (NIBP) and temperature patient monitors respectively of systems of the invention.

FIG. 10 depicts flow charts of operation of module units of the invention. In particular, FIG. 10 shows pressure/temperature flow and the depicted letter designations have the following meanings: A: Pressure/Temperature Values; B: Raw Pressure A/D Readings; C: Raw Temperature and Probe Resistance readings; D: Converted Temperature Data; E: Pressure Pulse Rate Value; F: Systolic, Diastolic, and Mean Values; G: Filtered Pressure Values; H: Pressure Zero Command; I: Filtered Pressure Waveform for Display; J: Zero Command from Host; K: Temperature Value and Status.

FIG. 11 depicts depict flow charts of operation of module units of the invention. In particular, FIG. 11 shows ECG processing flow and the depicted letter designations have the following meanings: A: Raw ECG Data and A/D Converter; B: Lead Selection Information; C: Lead Selection Information; D: Valid ECG Data; E: ECG Waveform Display Data; F: Filtered ECG Data for Beat Detection; G: ECG HR is 0 (possible asytole or vfib); H: Beat Detection Signal with QRS Information; I: ECG HR Value.

FIGS. 12 and 13 show further screen displays and outputs for transmission of various vital signs of a preferred system of the invention.

### DETAILED DESCRIPTION OF THE INVENTION

As discussed above, systems and methods of the invention can provide an effective data link between one or more patient monitoring units and an ultimate remote residence or user of the data.

Preferred monitoring systems of the invention may comprise one or more monitoring units; a module for receiving data output of the one or more monitoring units; and a computer unit. The module unit and the computer may be a single unit, but preferably are distinct units.

The module suitably acquires physiological data (e.g. 3, 5, or 12 lead ECG, non-invasive blood pressure, invasive blood pressure, temperature, pulse, SpO₂, CO₂, etc.) from a patient via one or more monitoring units. The module preferably converts the received physiological data to a digital format, and transfers the digital data to a computer e.g. over any standard serial connection such as RS-232, IR, RF, etc. One suitable module unit is a Medical Data Acquisition module, commercially available under the tradename of integritPC™ from Alliance Instruments of Vancouver, Wash.

A wide variety of computer units can be employed. A personal computer is generally preferred. Portable computers also are suitable such as a laptop computer. A patient's received physiologic information can be displayed on the computer unit and is transferred therefrom, e.g. to a patient's Electronic Medical Record, to a medical practitioner at a remote site, etc. The computer unit may communicate with the module unit in the computer's native operating system. A handshaking methodology and/or alarming structure between the module and the computer unit can be employed to ensure reliable data transfer and notification of error. Essentially any type of computer systems can be employed, including any of a wide variety of PC platforms. Preferably, the computer unit operates at a minimum speed of 100 MHz; higher speed systems are more preferred such as a 166 MHz system. WIN 32 bit application systems are also generally preferred.

Preferred monitoring systems of the invention can utilize a variety and more preferably essentially any open architecture computing platform, e.g. Windows, WindowsCE, Palm, Linux, etc. That is, a user can conveniently operate the computer in such a open architecture computing platform to facilitate analysis and transfer of data and adjustment to the one or more monitoring units.

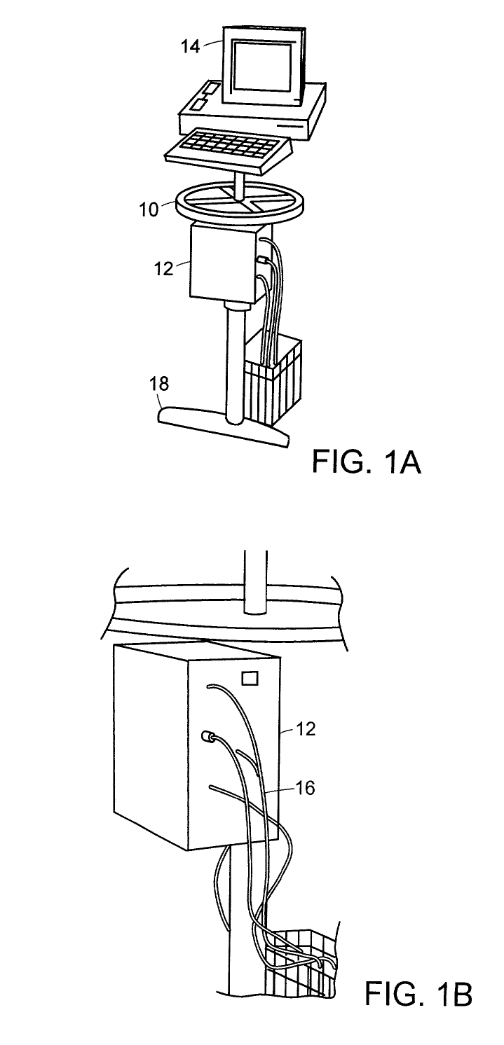

Referring now to the drawings, FIGS. 1A and 1B show a preferred monitoring system 10 of the invention that includes a module unit 12 (specifically, a commercially available integritiPC) in data communication with computer 14 and one or more patient monitoring units (not shown) such as through serial links 16. Components of the system (i.e. monitoring units, module unit and computer unit) are suitably hardwired for data communication, or alternatively data may be transferred wirelessly between one or more system components.

The module unit suitably need not contain a display or user interface. Rather, the linked computer unit can provide display and interface functions.

Through computer unit 14, a caregiver, either local or remote from the patient, can acquire data from one more patient monitoring units, store that data either locally or at a remote site such as an Electronic Patient Record and display the data for analysis or other manipulation. The data may be provided to computer unit in a variety of formats, e.g. in real-time or as trended values from the one or more monitoring units. The computer unit 14 also enables bidirectional data communication between the one or more monitoring units and the caregiver, i.e. the caregiver, either local or remote to a patient, may adjust the operation of or otherwise manipulate the one or more monitoring units.

Module unit 12 and computer unit 14 may be conveniently mounted on a cart unit 18, preferably a mobile cart that may be battery operated. The module unit 12 need only be connected to a patient when physiological data is to be collected. This configuration enables use of a single cart to collect physiological data from a significant number of patients, e.g. 5, 10, 15, 20 or more patients such as may be present in a sub-acute hospital treatment area.

The computer unit 14 also is capable of directly transferring data to a remote site, such as electronic patient record, without use of an interposed central server or the like. Computer unit 14 also is capable of transferring data through a server if desired, e.g. for transfer of data to a remote caregiver such as transfer via the Internet of physiological data to a remote physician.

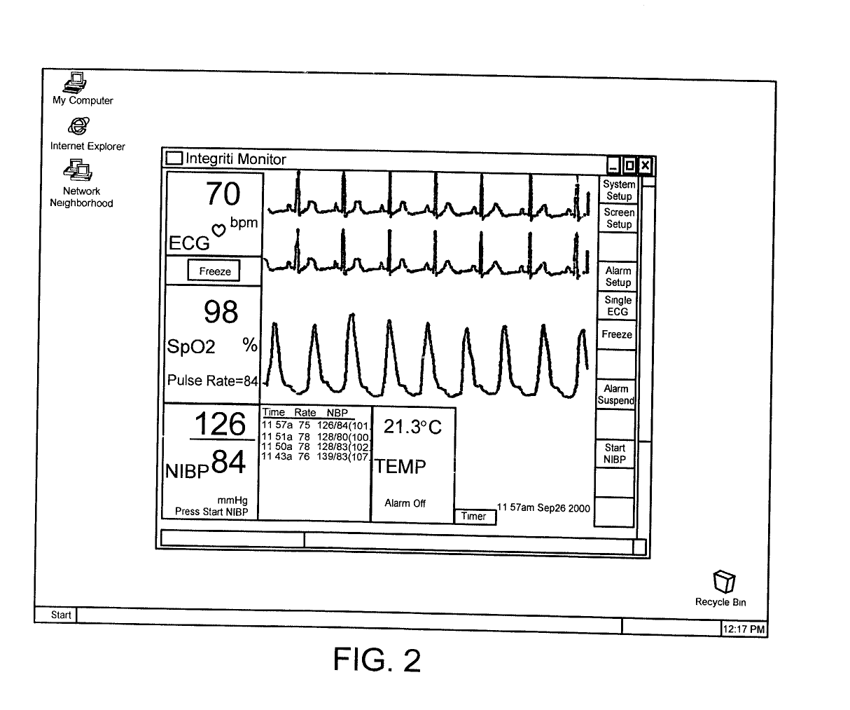

FIG. 2 depicts an exemplary display screen of computer unit 14. As depicted, the screen display employs a click-on format to make adjustments to a patient monitor's status and performance characteristics. The status of any setting can be clearly indicated on the control panels on the display. Preferably, any operation that can take the monitor off line or close a monitor application window is challenged by a popup message (e.g. “Are you sure you want to minimize vital signs display? YES NO”). Control panels may include a list of settings and their current values. Pull down windows and check boxes are used to change values. As shown in FIG. 2, softkeys along the right edge of the display screen allow a user to set up a monitor, review and document information, control aspects of the monitor's operation, and the like. The keys can be configured such that clicking on a key either brings up a popup control panel or performs the operation indicated on the key.

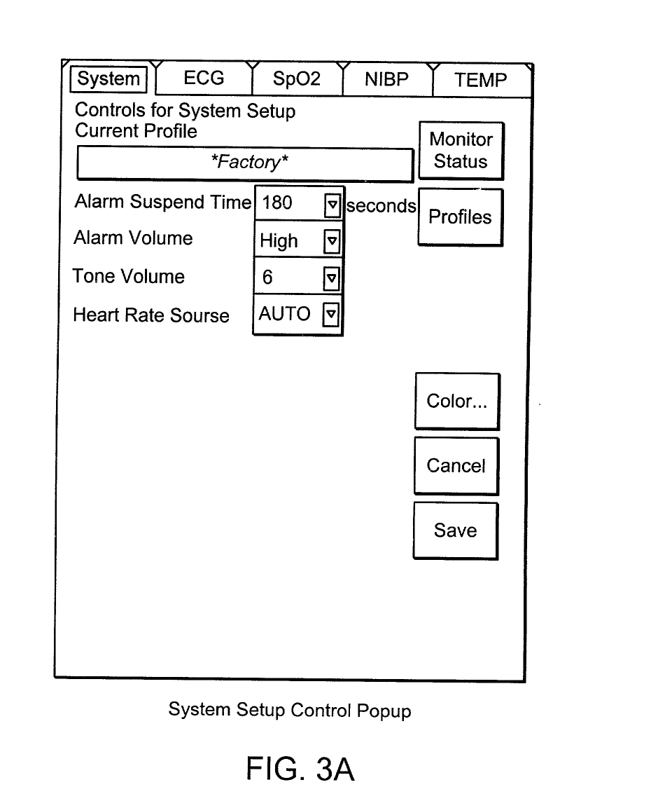

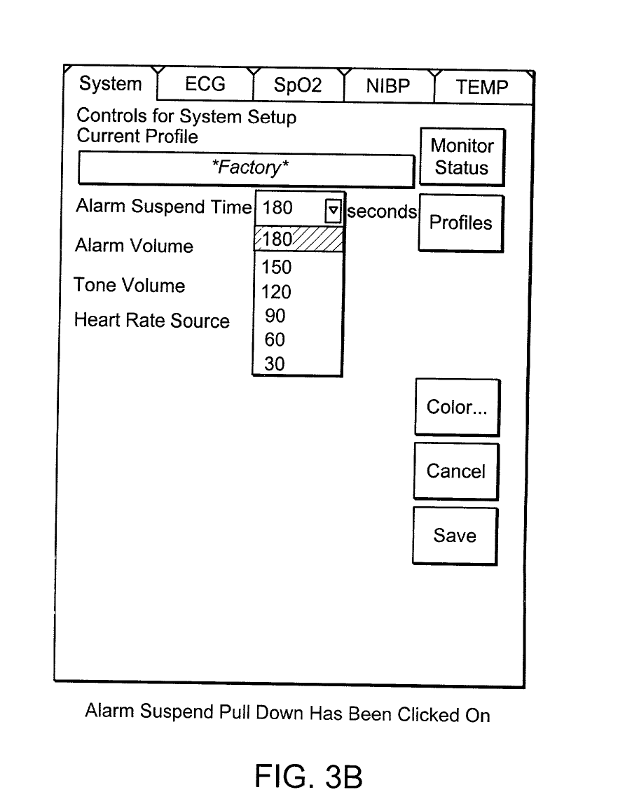

More particularly, clicking on the “System Setup” key provides a panel (exemplary panel shown in FIG. 3A) that shows the current status of system setting. Clicking a pull down can provide a range of possible settings for that item and the desired value. FIG. 3B shows an exemplary screen after a user has clicked the “Alarm suspend” setting.

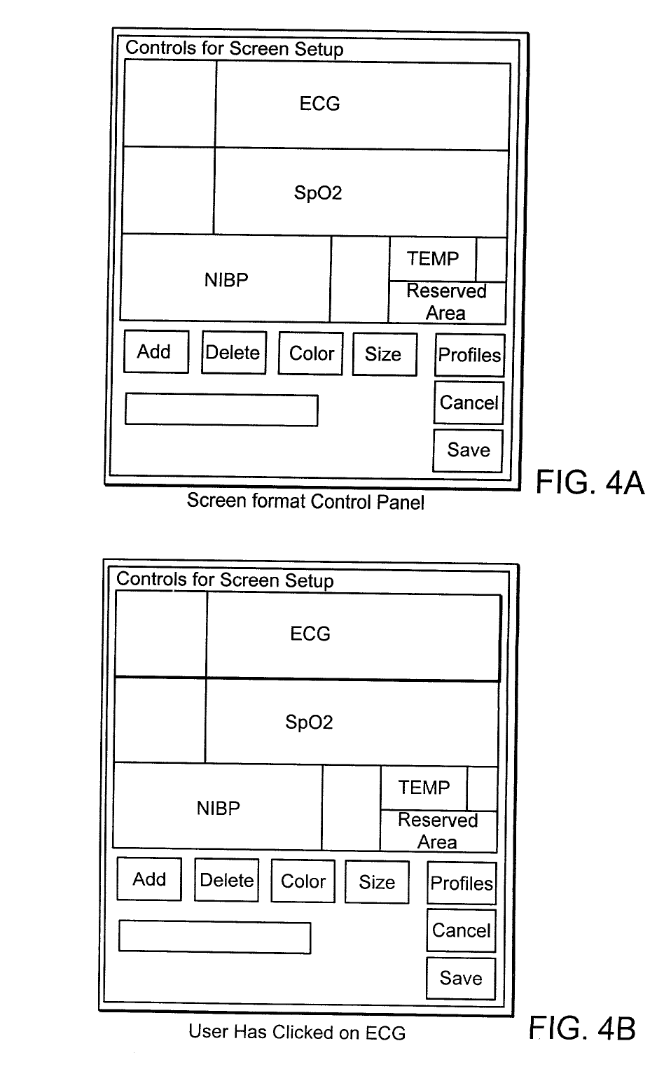

FIGS. 4A-4B show exemplary screen formatting operations. FIG. 4A shows a screen format control panel, and FIG. 4B shows a screen format once a user has selected (clicked) ECG. FIG. 4A depicts other monitored patient conditions (e.g. SpO₂, NIBP, temperature) that have a sensor (i.e. patient monitoring unit) in communication with module 12 and hence computer unit 14.

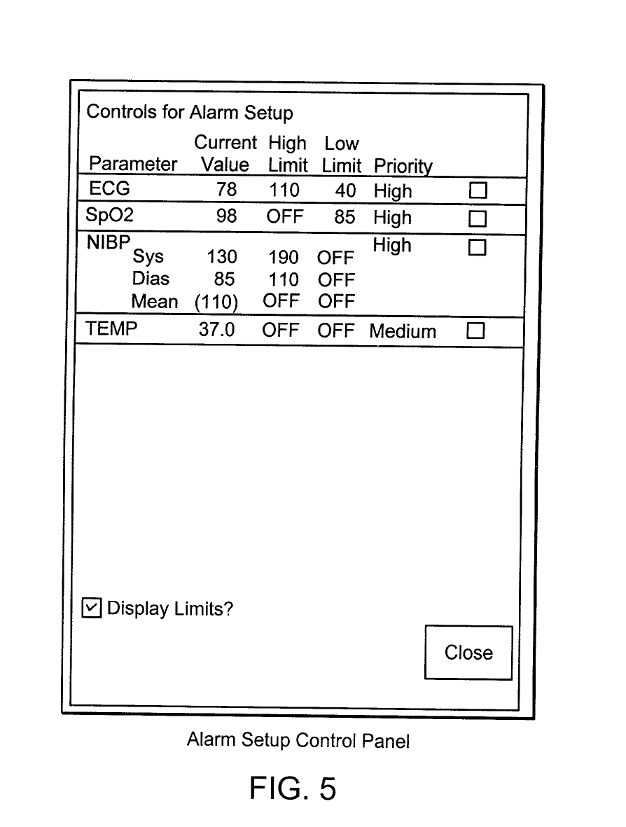

Clicking on the “Alarm Setup” key of FIG. 2 provides a control panel, with an exemplary screen shown in FIG. 5. As shown in that FIG. 5, the popup depicts all the current values for active parameters, alarm limit settings and whether the parameter will record when an alarm limit violation occurs.

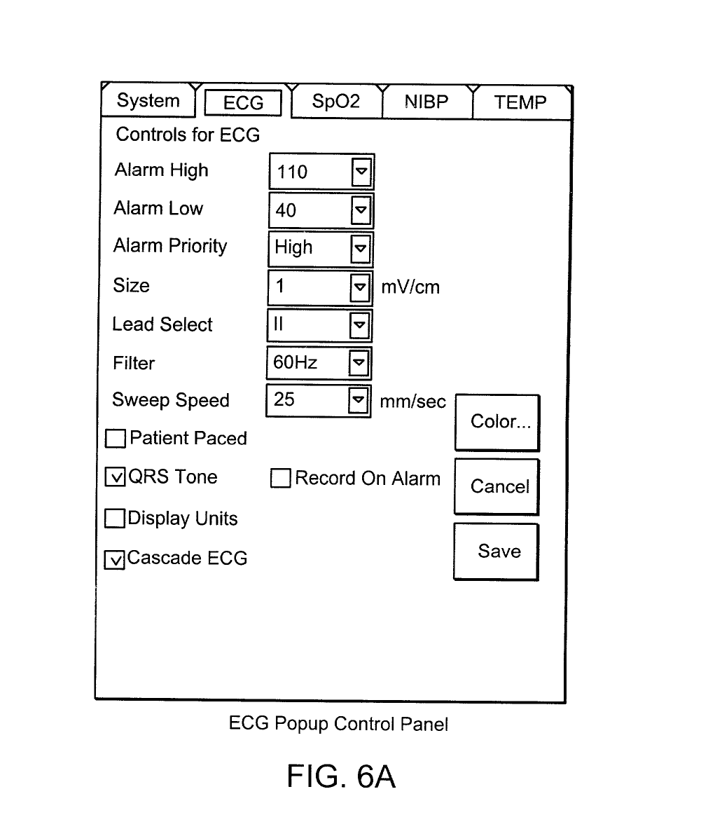

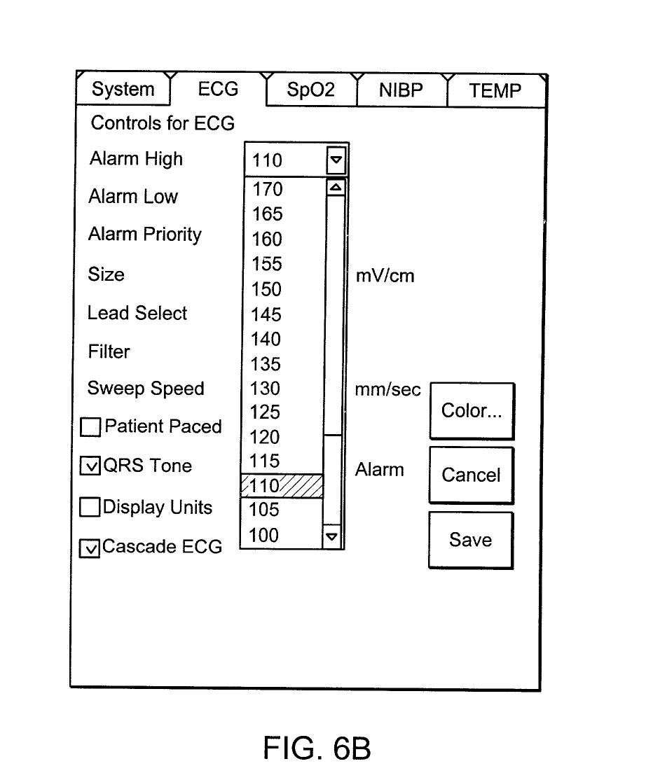

FIG. 6A depicts an exemplary control screen that is accessed when the ECG parameter label of FIG. 2 is clicked. Clicking on a value or status that is to be changed provides a range of choices for that selection, as shown in FIG. 6B which depicts the control screen with an alarm pull-down opened. Indicated changes can take effect when the “Save” is clicked. A user may cancel any indicated changes by clicking “Cancel” before exiting.

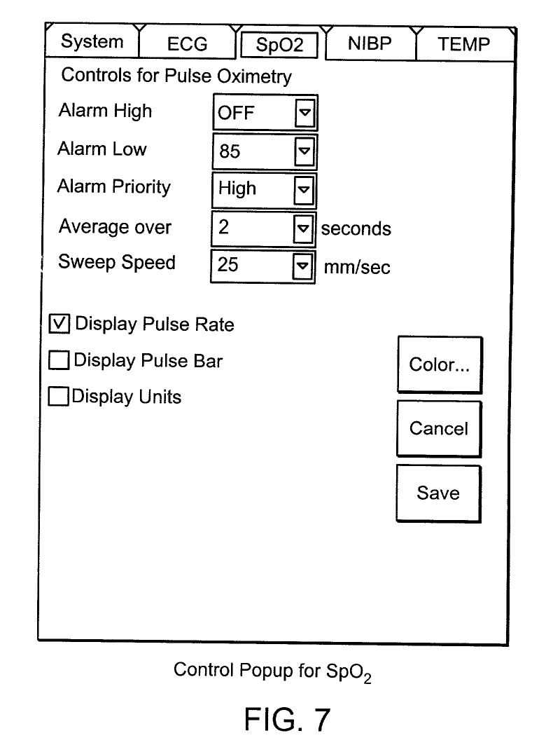

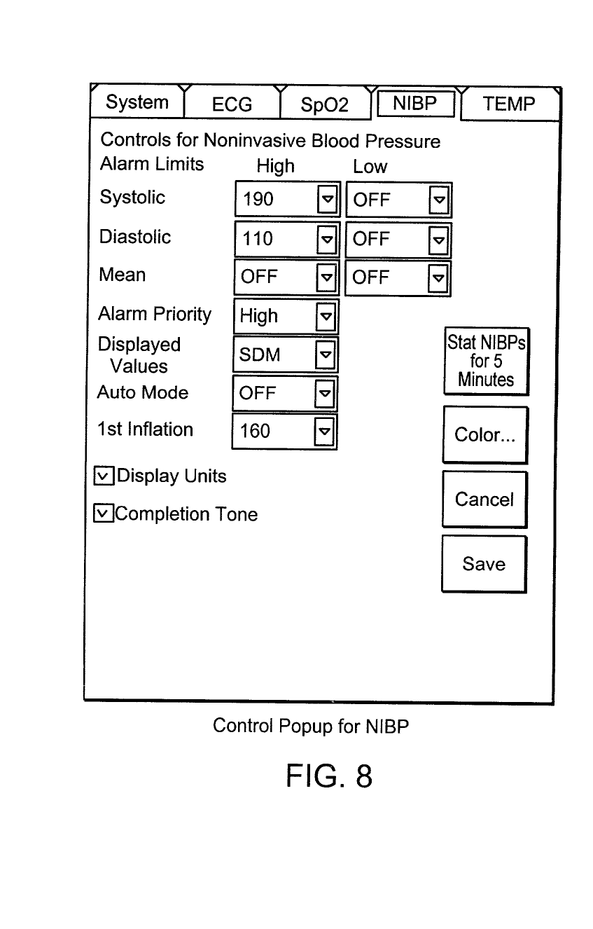

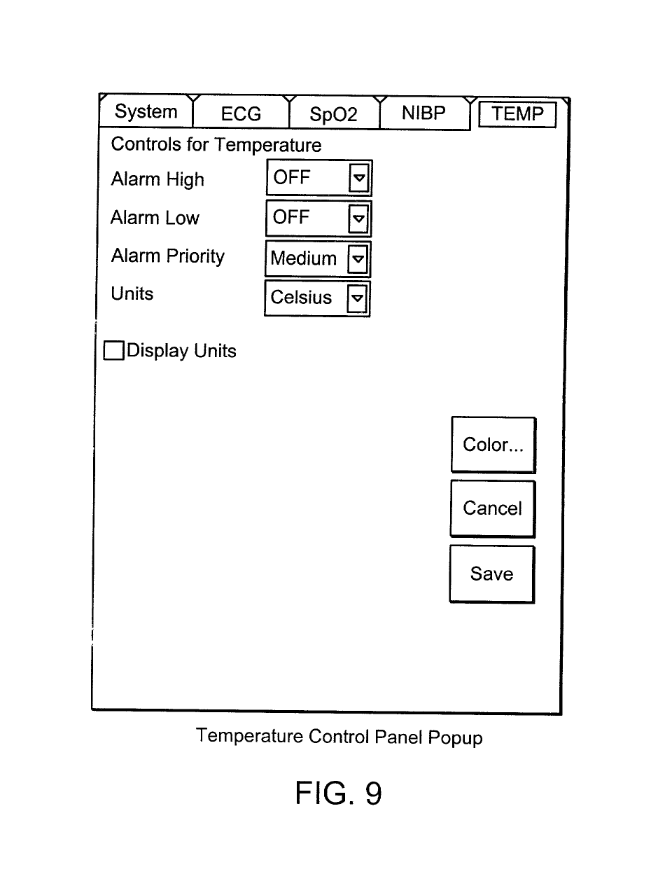

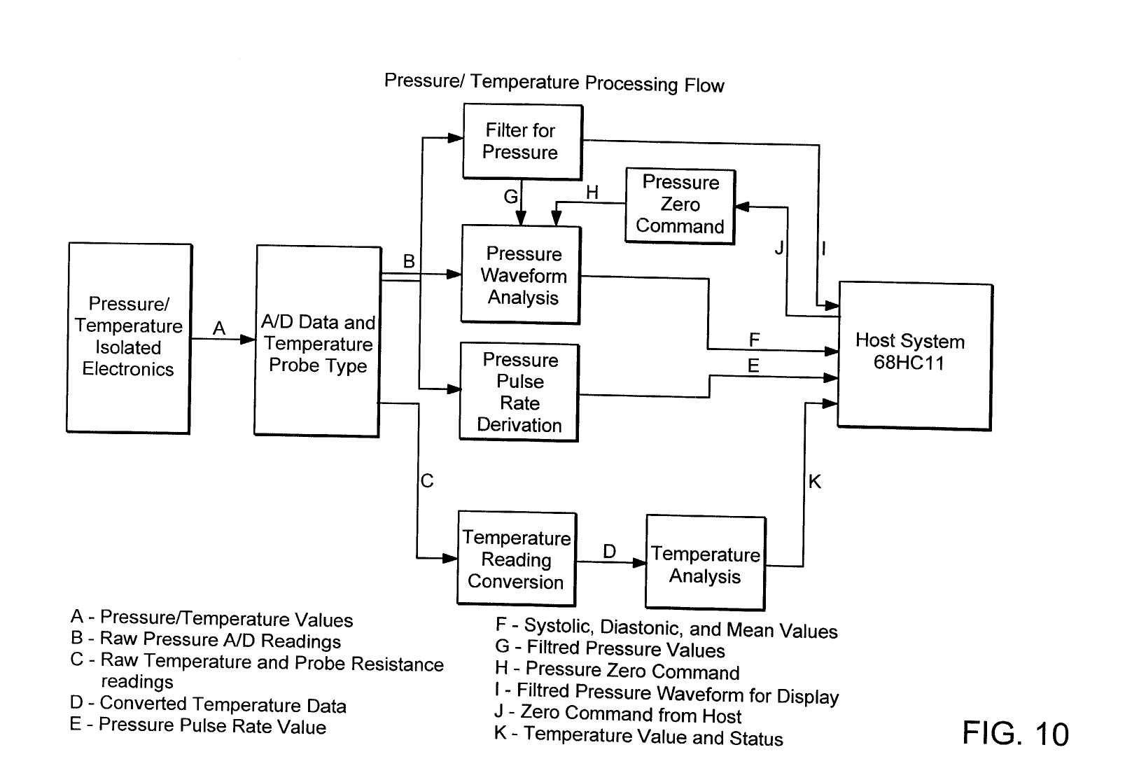

FIG. 7 depicts an exemplary control screen that is accessed when the SpO₂ parameter label of FIG. 2 is clicked. The operation of this screen is similar to that discussed above with respect to FIGS. 6A-6B, i.e. clicking on a value or status that is to be changed provides a range of choices for that selection; indicated changes can take effect when the “Save” is clicked; and a user may cancel any indicated changes by clicking “Cancel” before exiting. FIGS. 8 and 9 depict exemplary control screen that are accessed when the NIBP (non-invasive blood pressure) and temperature parameter labels of FIG. 2 are clicked. Operation of these screens are the same or similar as described for screens of FIGS. 6 and 7.

Currently available patient monitoring units can be employed in systems of the invention, e.g. current ECG, blood oxygen saturation measurement devices, noninvasive blood monitoring devices, patient temperature monitoring devices, and the like. As indicated, all of these monitoring devices can be operated through the computer unit 14, either directly, or from a remote site.

For instance, standard ECG monitoring units may be employed wherein the ECG unit is in data communication with a module unit 12. Blood pressure saturation is preferably measured from a module unit 12 via pulse oximetry unit. Such a pulse oximeter unit also can provide pulse rate and pulse waveform information. Sensors manufactured by Novametrix may be suitably employed, which measure pulse oximetry by passing light through a pulsating vascular bed, e.g. a finger, ear lobe, or bridge of a nose and detecting the ratio of red and near infrared light absorbed and transmitted. Pulse rate also can be calculated from the waveform generated from the pulsating vascular bed. The SpO₂ parameter measures functional hemoglobin, i.e. the amount of oxyhemoglobin as a percentage of hemoglobin that can be oxygenated.

Non-invasive blood pressure is suitably measured using the oscillometric method. With reference to FIG. 8, measurements may be initiated from computer unit 14 by clicking on the “Start NIBP” control on the depicted screen. A measurement is progress can be stopped by pressing the same key, which is labeled Stop NIBP during a measurement. A primary user screen as shown in FIG. 2 also can provide for commencing measurements of NIBP or any other patient function, without having to access a specific control screen. Computer unit 14 also can be programmed to automatically take readings at a user select.

Patient temperature can be suitably monitored with a variety of probe units, e.g. a YSI400 or YSI700 temperature probe positioned at a site to be monitored.

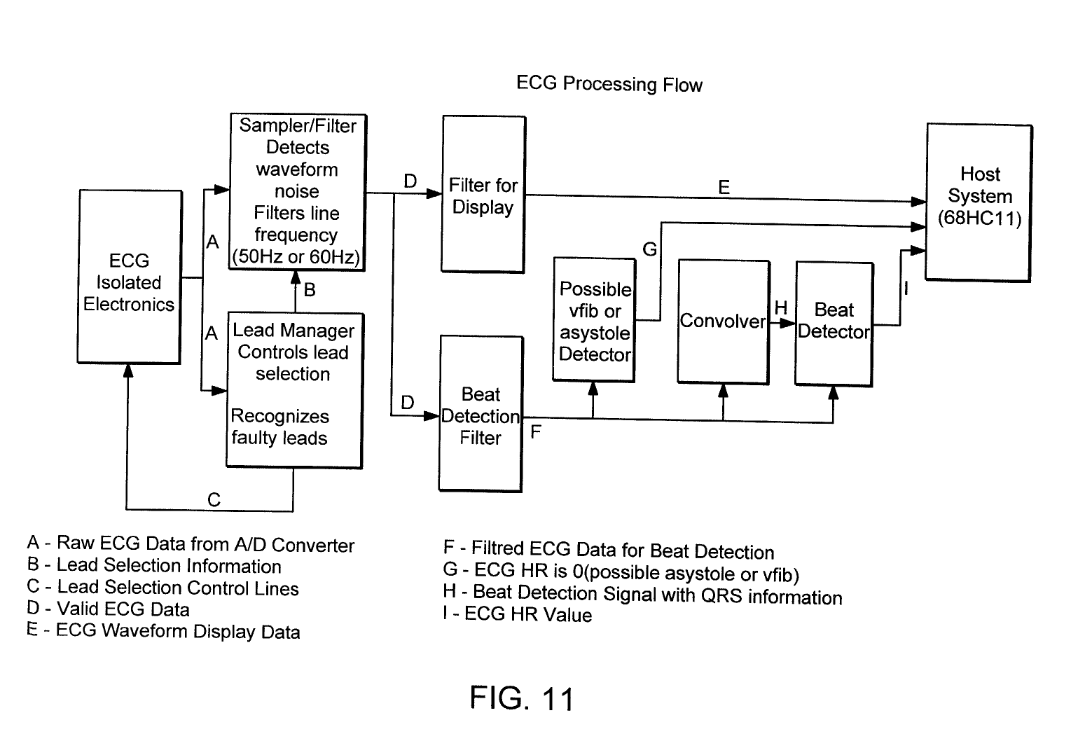

FIGS. 10 and 11 depict flow charts that depict suitable processing of specified data to digital form by the module unit 12.

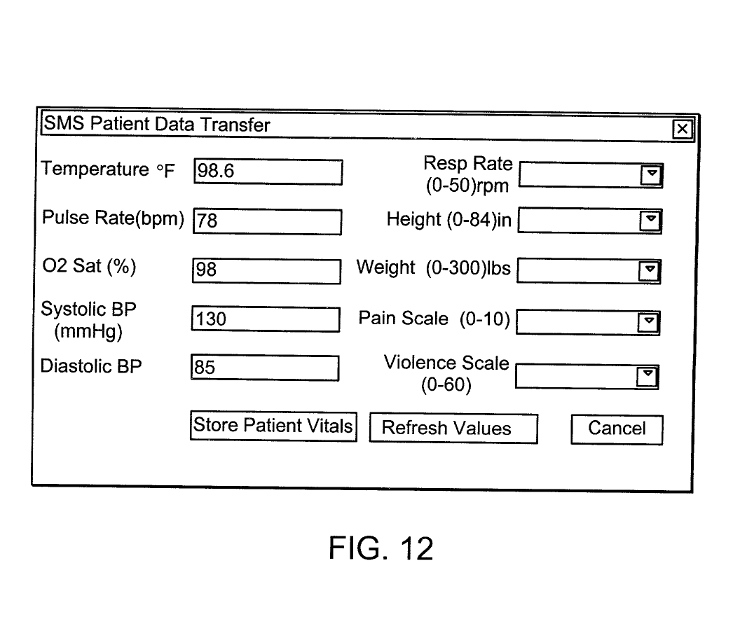

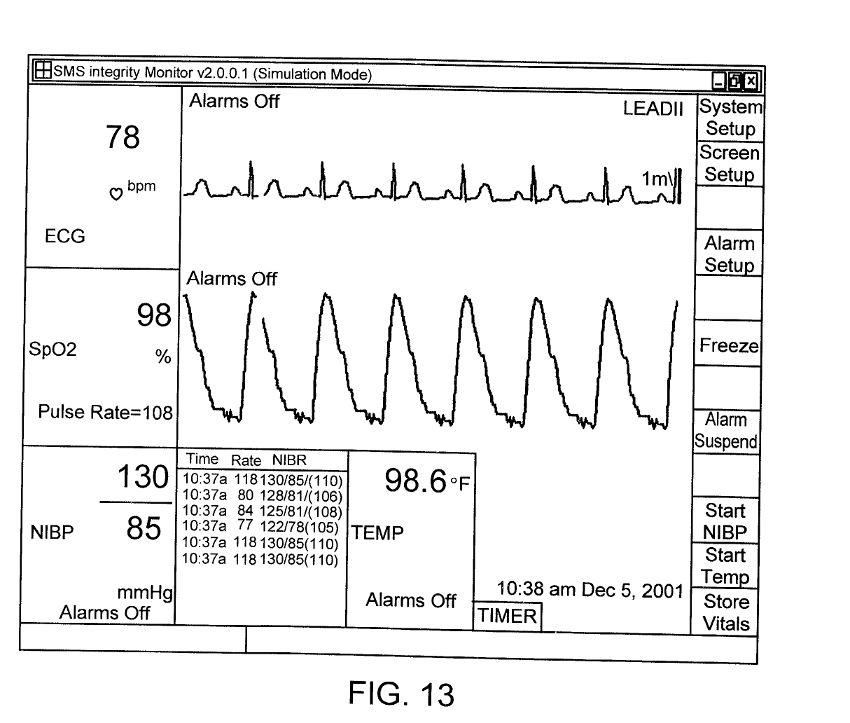

FIGS. 12 and 13 show further screen displays and outputs for transmission of various vital signs. In the screen shot shown in FIG. 12, a user can press the “Store Patient Vitals” button, which can generate the screen image shown in FIG. 13.

All documents mentioned herein are incorporated herein by reference.

The foregoing description of the invention is merely illustrative thereof, and it is understood that variations and modifications can be effected without departing from the spirit or scope of the invention as set forth in the following claims.

What is claimed is:

1. A system for monitoring a patient, comprising:
a) one or more patient monitoring units;
b) an electronic module unit to receive data of the one or more monitoring units; and
c) a computer unit for receiving and analysis of data from the module.

2. The system of claim 1 wherein the system comprises a plurality of monitoring units.

3. The system of claim 1 or 2 wherein the module unit digitizes received data.

4. The system of any one of claims 1 through 3 wherein the computer unit receives data in real-time from the one or more monitoring units.

5. The system of any one of claims 1 through 4 wherein the computer unit is in data communication with remotely located electronic patient records.

6. The system of any one of claims 1 though 5 wherein the computer unit is in data communication with a remote caregiver.

7. The system of any one of claims 1 through 6 wherein a data handshaking methodology exists for data transfer between the module unit and computer unit.

8. The system of any one of claims 1 through 7 wherein the module unit and computer unit are mounted on a movable cart unit.

9. The system of any one of claims 1 through 8 wherein the module unit does not comprise a display or user interface.

10. The system of any one of claims 1 through 9 wherein system components are hardwired.

11. The system of any one of claims 1 through 10 wherein one or more system components transmit data wirelessly.

12. A method for monitoring a patient, comprising:
a) providing a monitoring system comprising i) one or more patient monitoring units; ii) an electronic module unit to receive data of the one or more monitoring units; and iii) a computer unit for receiving and analysis of data from the module.
b) the one or more monitoring units providing data to the module unit; and
c) the module unit providing digitized data to the computer unit.

13. The method of claim 12 wherein the system comprises a plurality of monitoring units.

14. The method of claim 12 or 13 wherein the computer unit receives data in real-time from the one or more monitoring units.

15. The method of any one of claims 12 through 14 wherein the computer unit is in data communication with remotely located electronic patient records.

16. The method of claim 15 wherein the computer unit is in direct data communication with remotely located electronic data record without an interposed server.

17. The method of any one of claims 12 through 16 wherein data produced by the one or more monitoring units is stored in electronic patient records without manual recordation of the data.

18. The method of any one of claims 12 through 17 wherein data produced by the one or more monitoring units is transmitted from the computer unit directly without use of a server unit.

19. The method of any one of claims 12 through 18 wherein data produced by the one or more monitoring records is stored in electronic patient records in real-time of generation of the data.

20. The method of any one of claims 12 through 19 wherein the computer unit is in data communication with a remote caregiver.

21. The method of any one of claims 12 through 20 wherein a caregiver adjusts function of the one or more monitoring units via the computer unit.

22. The method of any one of claims 12 through 21 wherein the module unit and computer are used for analysis of physiological data of multiple patients.

23. The method of any one of claims 12 through 22 wherein data is transferred between the module unit and the computer unit with a handshaking protocol.

24. The method of any one of claims 12 through 23 wherein a user manipulates the computer unit in an open architecture computing platform.

25. The method of any one of claims 12 through 24 wherein a user manipulates the computer unit in Windows, WindowsCE, Palm, or Linux.

26. The method of any one of claims 12 through 25 wherein the module unit acquires from a patient physiological data of an ECG, non-invasive blood pressure, temperature, pulse, SpO₂, and/or or CO₂.

27. The method of any one of claims 12 through 26 wherein the module unit does not comprise a display or user interface.

28. The method of any one of claims 12 through 27 wherein system components are hardwired.

29. The method of any one of claims 12 through 27 wherein data is transmitted wirelessly between system components.
